(19) United States
(12) Patent Application Publication
(10) Pub. No.: US 2023/0049906 A1
(43) Pub. Date: Feb. 16, 2023

(54) CLEANING APPARATUS, CLEANING STATION AND METHOD FOR CLEANING A VEHICLE

(71) Applicant: ROBEL Bahnbaumaschinen GmbH, Freilassing (DE)

(72) Inventors: Gregor Schmid, Ainring (DE); Martin Knott, (US); Andreas Pfingstl, Freilassing (DE); Gerhard Sendlhofer, Kuchl (AT); Josef Flatscher, Saaldorf-Surheim (DE); Philipp Eisele, Hallwang (AT)

(21) Appl. No.: 17/951,330

(22) Filed: Sep. 23, 2022

Related U.S. Application Data
(63) Continuation of application No. PCT/EP2021/054966, filed on Mar. 1, 2021.

(30) Foreign Application Priority Data
Mar. 23, 2020 (DE) 10 2020 203 719.1

(51) Int. Cl. B60S 3/00; B60S 3/04; B25J 11/00; B25J 15/00; B25J 9/16

(52) U.S. Cl. CPC B60S 3/006; B60S 3/04; B25J 11/0085; B25J 15/0019; B25J 9/1679

(57) ABSTRACT

A cleaning apparatus includes at least one detection device for detecting soiling on a vehicle to be cleaned and at least one cleaning device for cleaning the vehicle. A control device controls the at least one cleaning device in dependence on the detected soiling. The at least one cleaning device includes at least one multi-axis robot for positioning a cleaning element relative to the vehicle. The cleaning apparatus enables simple, fast and reliable automatic cleaning of the vehicle.

### CROSS-REFERENCE TO RELATED APPLICATION

This application is a continuation, under 35 U.S.C. § 120, of copending International Patent Application PCT/EP2021/054966, filed Mar. 1, 2021, which designated the United States; this application also claims the priority, under 35 U.S.C. § 119, of German Patent Application DE 10 2020 203 719.1, filed Mar. 23, 2020; the prior applications are herewith incorporated by reference in their entireties.

### FIELD AND BACKGROUND OF THE INVENTION

The invention relates to a cleaning apparatus and a method for cleaning a vehicle, in particular a rail vehicle.

Rail vehicles are regularly damaged by sprayers applying spray paint or graffiti. In extreme cases, connection failures may occur if the windows of the rail vehicle in the region of the driver's cab are dirty and the rail vehicle is not operational as a result.

### SUMMARY OF THE INVENTION

It is an object of the invention to provide a cleaning apparatus that enables simple, fast and reliable automatic cleaning of a vehicle, in particular a rail vehicle.

The object is achieved by a cleaning apparatus for cleaning a vehicle, in particular a rail vehicle, containing at least one detection device for detecting soiling on a vehicle to be cleaned, at least one cleaning device for cleaning the vehicle having at least one cleaning element, at least one multi-axis robot for positioning the at least one cleaning element relative to the vehicle, and a control device for controlling the at least one cleaning device in dependence on the detected soiling. Soiling on the vehicle to be cleaned is detected by means of the at least one detection device. The at least one detection device preferably contains at least one light sensor or optical detector in each case. The at least one detection device is in signal connection with the control device. The control device creates at least one cleaning program for controlling the at least one cleaning device on the basis of the detected soiling. The control device controls the at least one cleaning device depending on the detected soiling. For cleaning the vehicle, the control device controls in particular the at least one multi-axis robot. The at least one multi-axis robot holds the at least one associated cleaning element and positions the latter relative to the vehicle in such a way that the detected soiling is removed. The detection of the soiling on the vehicle to be cleaned and the subsequent cleaning of the vehicle or removal of the soiling is performed automatically. The cleaning apparatus thus enables simple, fast and reliable cleaning of the vehicle. The vehicle is in particular a road vehicle, such as a truck and any trailer, and/or a rail vehicle, such as a commuter train and/or a long-distance train.

A cleaning apparatus containing at least one inspection device for inspecting the cleaned vehicle ensures a simple, fast and reliable automatic cleaning. The at least one inspection device inspects the cleaned vehicle or the cleaning result. The cleaning result is documented in particular by means of the at least one inspection device. The at least one inspection device preferably contains at least one light sensor or optical detector in each case. The at least one inspection device is preferably in signal connection with the control device. If the cleaning result is not acceptable, the control device creates in particular a post-cleaning program. By means of the post-cleaning program, the control device controls the at least one cleaning device for post-cleaning the vehicle. The control device controls the at least one cleaning device, for example, in such a way that the at least one multi-axis robot holds a cleaning element that differs from the first cleaning and positions it in such a way that the remaining soiling is removed. Preferably, the cleaning and the post-cleaning are performed by means of different cleaning parameters and/or different cleaning elements, for example by means of a brush and a nozzle.

A cleaning apparatus configured such that the at least one detection device and/or the at least one inspection device each contains at least one digital camera ensures simple, fast and reliable automatic cleaning. By means of the respective digital camera, digital image data of the vehicle to be cleaned or of the cleaned vehicle are obtained. The digital image data are evaluated by the control device, for example, to create a cleaning program or to create a post-cleaning program.

In a first embodiment, the at least one detection device and/or the at least one inspection device each contains a beam on which at least one digital camera, in particular at least two digital cameras, are arranged. The at least two digital cameras are preferably fixedly arranged at the beam and/or in particular spaced apart from each other in a vertical direction. This ensures that the at least two digital cameras capture a side wall of the vehicle over its entire height.

In a second embodiment, the at least one detection device and/or the at least one inspection device each contains a beam at which at least one digital camera is displaceably arranged. The beam is, for example, configured as a column and the at least one digital camera is movable on the beam by means of a linear drive. Furthermore, the beam is configured, for example, as a base component of a multi-axis robot, on which the at least one digital camera is arranged. The at least one digital camera can be positioned in a simple manner relative to the vehicle by means of the respective multi-axis robot for capturing the entire height of a side wall of the vehicle. The respective multi-axis robot contains at least three movement axes, in particular at least four movement axes, and in particular at least five movement axes. Preferably, the respective multi-axis robot contains at most six movement axes. The movement axes are preferably designed as swivel axes.

A cleaning apparatus configured such that the at least one detection device and/or the at least one cleaning device and/or the at least one inspection device are arranged one after the other in a process direction ensures simple, fast and reliable automatic cleaning. The process direction runs parallel to a longitudinal direction of the vehicle to be cleaned. Due to the fact that the at least one cleaning device is arranged downstream of the at least one detection device, soiling can first be detected by means of the at least one detection device, so that a cleaning program can be determined by means of the control device and the at least one cleaning device can then be controlled by means of this cleaning program. Due to the fact that the at least one inspection device is arranged downstream of the at least one cleaning device in the process direction, the cleaning result can be checked and/or documented. The remaining soiling detected by means of the at least one inspection device can in particular be compared with the original soiling detected by means of the at least one detection device, so that the cleaning result can be evaluated and/or a post-cleaning program can be created by means of the control device. Preferably, the cleaning apparatus has at least two detection devices and/or at least two cleaning devices and/or at least two inspection devices, for being arranged on a first side of the vehicle and on an opposite second side of the vehicle. The at least two detection devices and/or the at least two cleaning devices and/or the at least two inspection devices are arranged in particular on the respective side of the vehicle in succession in the process direction. The at least two detection devices and/or the at least two inspection devices can also be used in conjunction with at least one cleaning device which can be positioned on the first side and on the second side of the vehicle.

A cleaning apparatus configured such that the at least one cleaning device contains at least one support at which the at least one multi-axis robot is arranged ensures simple, fast and reliable automatic cleaning. The at least one multi-axis robot is preferably arranged to be movable on the beam by means of a drive. This allows the at least one multi-axis robot to be flexibly positioned for cleaning the vehicle. Preferably, the beam is designed in a portal-like manner for displacing the at least one multi-axis robot from a first side of the vehicle to a second opposite side of the vehicle. In particular, the at least one cleaning device has at least two multi-axis robots in each case, which are arranged on a common beam and/or on a separate beam in each case. The at least two multi-axis robots are arranged in particular in a movable manner on the common support or the respective support. Preferably, the at least two multi-axis robots are movable perpendicularly to a process direction and/or parallel to a process direction.

A cleaning apparatus configured such that the at least one multi-axis robot comprises at least three, in particular at least four, and in particular at least five movement axes ensures simple, fast and reliable automatic cleaning. Preferably, the at least one multi-axis robot has at least three and/or at most six movement axes. In particular, the movement axes are designed as swivel axes. Preferably, the at least one multi-axis robot contains a holding fixture for holding the at least one cleaning element. In particular, the holding fixture can be automatically released and automatically clamped so that the at least one cleaning element can be automatically changed. Preferably, the at least one cleaning device contains a magazine for holding at least two different cleaning elements.

A cleaning apparatus configured such that the at least one multi-axis robot contains at least one sensor for detecting the soiling ensures a simple, fast and reliable automatic cleaning. The at least one sensor ensures an identification or recognition of the detected soiling. Preferably, the at least one sensor is designed as a light sensor or optical detector. Preferably, at least one digital camera, which contains the at least one sensor, is arranged on the at least one multi-axis robot. In particular, the at least one sensor is arranged in the region of a holding fixture for the at least one cleaning element.

A cleaning apparatus configured such that the at least one cleaning device contains at least one provision unit for providing a cleaning medium, in particular for providing dry ice ensures simple, fast and reliable automatic cleaning. Preferably, the cleaning medium is dry ice and/or dry ice pellets and/or a chemical cleaning liquid and/or water. Preferably, the at least one cleaning device contains a provision unit for providing dry ice and/or a provision unit for providing a chemical cleaning liquid. In particular, the provision unit contains a reservoir for storing the cleaning medium and/or a conveying element for conveying the cleaning medium and/or a conveying line for conveying the cleaning medium to an associated cleaning element.

A cleaning apparatus configured such that the provision unit contains a dry ice generator and/or a dry ice reservoir ensures simple, fast and reliable automatic cleaning. The provision unit serves to provide dry ice or dry ice pellets. The dry ice generator is connected in particular to a CO₂ storage container. The dry ice generator preferably contains a pelletizer. The dry ice reservoir is in particular designed as a container. The dry ice reservoir is preferably thermally insulated. The dry ice generator is connected in particular to the dry ice reservoir, so that the dry ice produced is automatically stored in the dry ice reservoir.

The provision unit preferably contains a compressed air generator and/or a compressed air reservoir. The compressed air serves to dispense the dry ice or to generate a dry ice-compressed air mixture. Preferably, the provision unit has a metering unit for generating a dry ice-compressed air mixture.

The provision unit preferably contains a dry ice dispenser having a drive unit and at least one contact body displaceable by means of the drive unit for accelerating the dry ice to a dispensing speed. This enables the dry ice to be dispensed or emitted completely without compressed air or with a reduction in the compressed air flow and/or the amount of compressed air used.

The dry ice or dry ice pellets hit the soiling with a high impact energy. Due to the temperature influences, the sublimation of the dry ice and the impact energy, soiling is effectively removed. Preferably, the dry ice is made from liquid CO₂. The dry ice is dispensed in particular by means of a nozzle as a cleaning element.

A cleaning apparatus configured such that the at least one cleaning element contains a nozzle and/or a brush ensures simple, fast and reliable automatic cleaning. Preferably, the cleaning apparatus contains at least two different cleaning elements. In particular, the at least two cleaning elements are arranged in a magazine so that the at least one multi-axis robot can perform an automatic change of a cleaning element. The at least one cleaning element comprises, for example, a nozzle for dispensing or spraying a chemical cleaning liquid and/or a dry ice-compressed air mixture and/or dry ice pellets and/or water. The at least one cleaning element comprises, for example, a brush. The brush is, for example, rotatably drivable. Preferably, the brush and the nozzle are combined for mechanical cleaning by means of the cleaning medium.

A cleaning apparatus containing a travel motion control device for controlling the travel motion of the vehicle to be cleaned in dependence on the detected soiling ensures simple, fast and reliable automatic cleaning. The travel motion control device enables, in particular, a partially automated and/or fully automated control of the travel motion of the vehicle to be cleaned.

For partially automated control, the travel motion control device contains at least one optical and/or acoustic control element. The control element serves to inform a driver of the vehicle to be cleaned. By means of the at least one control element, the driver receives, in particular, information as to whether and/or at what speed and/or in which direction of travel the driver is to move the vehicle to be cleaned. Preferably, the at least one control element contains a visual display for the driver. Preferably, a plurality of optical displays is provided, which are arranged along a process direction.

For fully automated control, the travel motion control device contains a transmitter and/or a receiver for transmitting and/or receiving control signals for controlling the travel motion. The travel motion control device is in signal connection with a vehicle control device, so that the travel motion of the vehicle to be cleaned is specified by the travel motion control device. A driver is not required during the cleaning of the vehicle.

It is further an object of the invention to provide a cleaning station that enables simple, fast and reliable automatic cleaning of a vehicle, in particular a rail vehicle.

This object is achieved by a cleaning station for cleaning a vehicle, in particular a rail vehicle, containing a travel path, in particular a track, and a cleaning apparatus according to the invention. The cleaning apparatus is arranged in particular laterally next to the travel path. The travel path is preferably rectilinear in shape. The cleaning apparatus is arranged to be at least partially stationary. Preferably, the travel path and the cleaning apparatus are arranged on a common ground. The travel path or a longitudinal direction of the vehicle to be cleaned defines a process direction for cleaning the vehicle. In particular, the cleaning station contains a protective device. The protective device serves to prevent persons from accessing the travel path and/or the cleaning apparatus. Preferably, the protective device at least partially surrounds the travel path and the cleaning apparatus and forms an outer boundary of the cleaning station. The protective device is configured, for example, as a protective fence and/or a protective housing.

A cleaning station configured such that the at least one detection device and/or the at least one cleaning device and/or the at least one inspection device are arranged one after the other and/or laterally next to the travel path in a process direction ensures simple, fast and reliable automatic cleaning. The at least one detection device and the at least one cleaning device and, if applicable, the at least one inspection device are arranged in particular on a common side next to the travel path, so that one side of the vehicle can be cleaned. The cleaning station contains, for example, two detection devices which are arranged on a first side and on a second side next to the travel path, and/or one cleaning device which is positionable on a first side and on a second side of the travel path, and/or two inspection devices which are arranged on the first side and on the second side.

A cleaning station configured such that a first detection device and/or a first cleaning device and/or a first inspection device is arranged on a first side next to the travel path, and that a second detection device and/or a second cleaning device and/or a second inspection device is arranged on a second side next to the travel path ensures simple, fast and reliable automatic cleaning. Preferably, a detection device, a cleaning device and an inspection device are arranged one after the other in the process direction on each side of the travel path or of the vehicle to be cleaned. This allows both sides of the vehicle to be cleaned simultaneously.

It is another object of the invention to provide a method that enables simple, fast and reliable automatic cleaning of a vehicle, in particular a rail vehicle.

This object is achieved by a method for cleaning a vehicle, in particular a rail vehicle, containing the steps of providing a cleaning station according to the invention, moving the vehicle along the travel path, detecting soiling on the vehicle by means of the at least one detection device, controlling the at least one cleaning device in dependence on the detected soiling by means of the control device, and cleaning of the vehicle by means of the at least one cleaning device. The advantages of the method according to the invention correspond to the advantages of the cleaning station according to the invention or the cleaning apparatus according to the invention already described. Preferably, the moving of the vehicle is carried out in a partially automated and/or fully automated manner by means of a motion control device. Preferably, the moving of the vehicle takes place in time intervals with interruptions or continuously. Preferably, the moving of the vehicle is performed at a constant speed. Based on the constant speed and a distance between the at least one detection device and the at least one cleaning device, the position of a detected soiling relative to the at least one cleaning device can be determined. After cleaning the vehicle, an inspection of the cleaned vehicle can be performed by means of at least one inspection device. The cleaned vehicle or the cleaning result can be documented and evaluated by means of the at least one inspection device. If the evaluation results in an unacceptable cleaning result, the vehicle can be post-cleaned by means of the at least one cleaning device. For this purpose, the at least one cleaning device can be controlled by means of the control device in dependence on the detected cleaning result or the detected residual soiling. The control device operates the at least one cleaning device during initial cleaning of the vehicle and during subsequent cleaning of the vehicle, in particular with different cleaning parameters. Cleaning parameters are, for example, a cleaning element to be used, a cleaning medium, a mass flow, a pressure and/or a temperature. The cleaning of the vehicle is carried out in particular in such a way that dry ice is applied to the soiling.

Other features which are considered as characteristic for the invention are set forth in the appended claims.

Although the invention is illustrated and described herein as embodied in a cleaning apparatus and a method for cleaning a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic top view of a cleaning station according to a first embodiment of the invention having detection devices, cleaning devices and inspection devices;

FIG. 2 is a partial sectional view through the cleaning station according to FIG. 1 taken along the section line II-II shown in FIG. 1 to illustrate the detection devices;

FIG. 3 is a partial sectional view through the cleaning station taken along the section line III-III shown in FIG. 1 to illustrate the cleaning devices;

FIG. 4 is a partial sectional view through the cleaning station according to FIG. 1 along section line IV-IV to illustrate the inspection devices;

FIG. 5 is a partial sectional view through the cleaning station according to a second embodiment to illustrate the detection devices;

FIG. 6 is a partial sectional view through the cleaning station according to the second embodiment to illustrate a movable cleaning device; and

FIG. 7 is a partial sectional view through the cleaning station according to the second embodiment to illustrate the inspection devices.

### DETAILED DESCRIPTION OF THE INVENTION

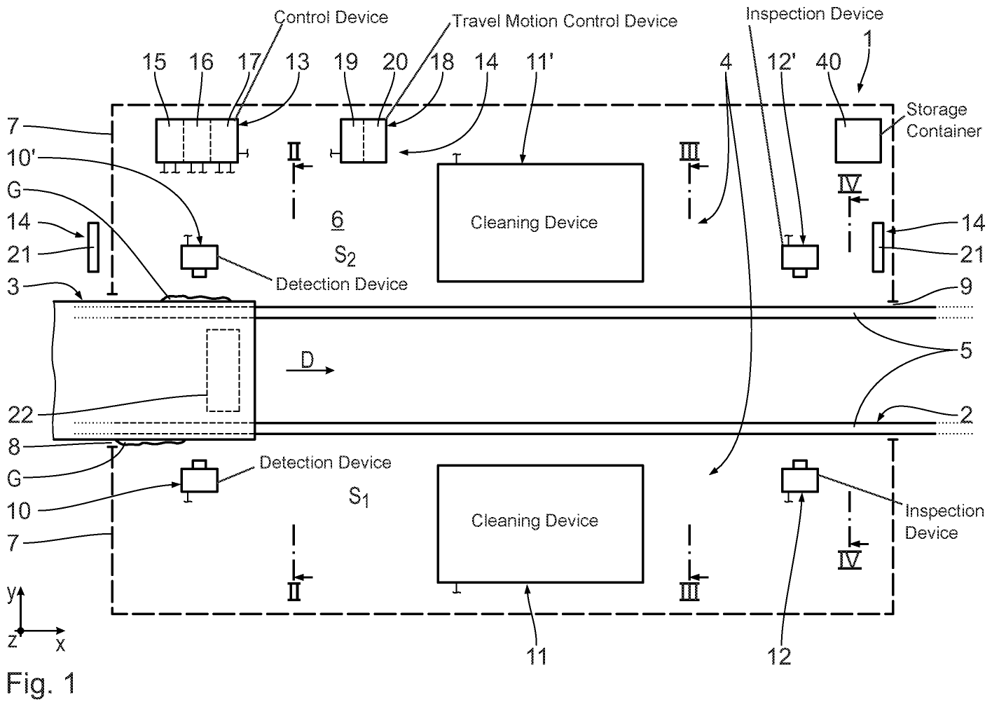

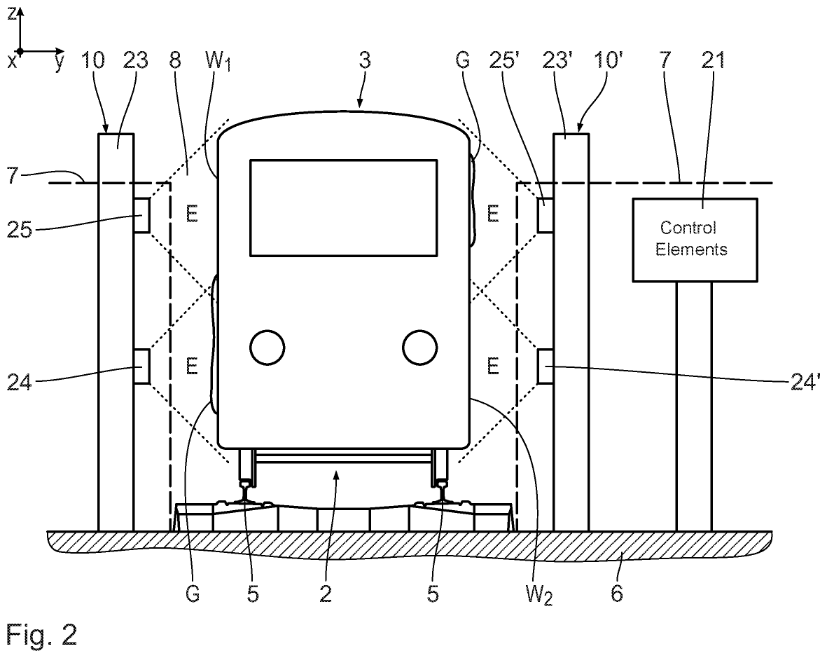

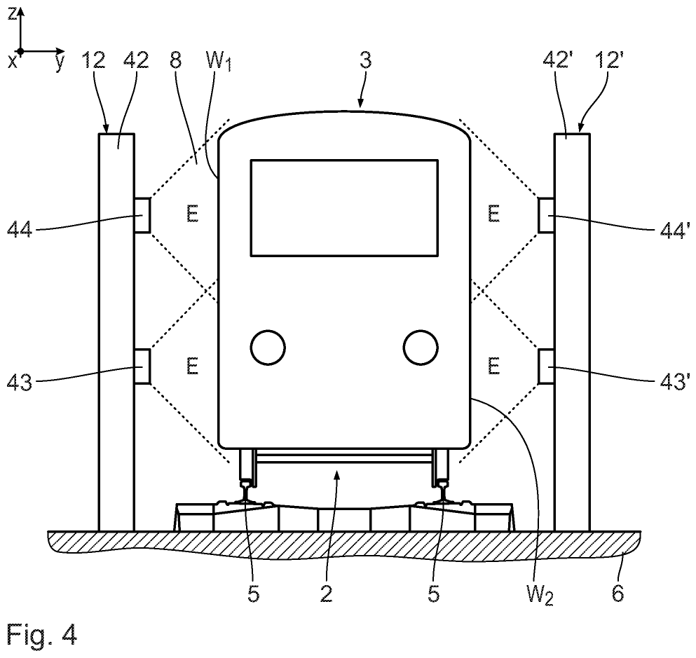

Referring now to the figures of the drawings in detail and first, particularly to FIGS. 1-4 thereof, there is shown a first embodiment of the invention. A cleaning station 1 shown in FIG. 1 contains a travel path formed as a track 2 for a rail vehicle 3. The track 2 includes two rails 5 which are arranged and fastened to a ground 6. The rails 5 extend in an x-direction and are spaced apart in a y-direction perpendicular to the x-direction.

For cleaning the rail vehicle 3, the cleaning station 1 has a cleaning apparatus 4. The cleaning apparatus 4 is arranged to be stationary or fastened to the ground 6 laterally next to the rails 5. The cleaning station 1 contains a protective device 7 which laterally surrounds the cleaning apparatus 4 and the section of the track 2 defined by the cleaning apparatus 4, with the exception of an entrance 8 and an exit 9. The protective device 7 is configured, for example, as a protective fence or as a protective housing.

The cleaning apparatus 4 has a first detection device 10, a first cleaning device 11 and a first inspection device 12, which are arranged one after the other on a first side S₁ of the track 2 in a process direction D. The process direction D runs in the direction of the track 2 from the first detection device 10 to the first cleaning device 11 or from the first cleaning device 11 to the first inspection device 12. The process direction D runs parallel to the x-direction.

The cleaning apparatus 4 further has a second detection device 10′, a second cleaning device 11′, and a second inspection device 12′ arranged one after the other on a second side S₂ of the track 2 opposite to the first side S₁ in the process direction D.

The cleaning apparatus 4 has a control device 13 and a travel motion control device 14. The control device 13 has a central control unit 15, a cleaning control unit 16 and a travel motion control unit 17. The control device 13 is in signal connection with the detection devices 10, 10′, the cleaning devices 11, 11′ and the inspection devices 12, 12′ as well as with the travel motion control device 14.

The travel motion control device 14 serves for partially automated and/or fully automated control of the travel motion of the rail vehicle 3 to be cleaned. The travel motion control device 14 contains a transmitting and receiving unit 18 having a transmitter 19 and a receiver 20 for wireless transmission of control signals. The travel motion control device 14 further comprises a plurality of control elements 21 in the form of display panels which are arranged in the process direction D along the track 2. The control elements 21 are in signal connection with the transmitting and receiving unit 18. In the case of automatic control of the travel motion of the rail vehicle 3, the transmitting and receiving unit 18 is in signal connection with a vehicle control device 22 of the rail vehicle 3.

The detection devices 10, 10′ serve to detect soiling G on the rail vehicle 3 to be cleaned. The detection devices 10, 10′ each contain a column-like beam 23 or 23′ and associated digital cameras 24, 25 or 24′, 25′. The respective beam 23, 23′ is firmly connected to the ground 6. The digital cameras 24, 25, 24′, 25′ are arranged at a distance from one another in a vertical z-direction at the respective associated beam 23, 23′. The z-direction is perpendicular to the x-direction and the y-direction. The digital cameras 24, 25, 24′, 25′ have a respective detection area E. The digital cameras 24, 25, 24′, 25′ are arranged in such a way that the detection areas E completely capture side walls W₁ and W₂ of the rail vehicle 3. The digital cameras 24, 25, 24′, 25′ have a respective light sensor or optical detector which converts light into image data in the usual manner. The image data is provided to the control device 13.

The cleaning devices 11, 11′ serve to clean the rail vehicle 3 or to remove the detected soiling G. The cleaning devices 11, 11′ each comprise a multi-axis robot 26, 26′, an associated cleaning module 27, 27′ and an associated provision unit 28, 28′ for providing a cleaning medium in the form of dry ice P or dry ice pellets. The respective multi-axis robot 26, 26′ is attached to the ground 6 by a base component 29, 29′. The respective multi-axis robot 26, 26′ contains six movement axes B₁ to B₆. The movement axes B₁ to B₆ are configured as swivel axes. The movement axis B₆ is formed by a respective holding fixture 30, 30′ for holding the associated cleaning module 27, 27′.

The respective cleaning module 27, 27′ contains a holder 31, 31′, which is clamped or tensioned in the associated holding fixture 30, 30′. A cleaning element 32, 32′ and a protective cover 33, 33′ are attached to the respective holder 31, 31′. The cleaning elements 32, 32′ are configured as nozzles for dispensing a dry ice-compressed air mixture M.

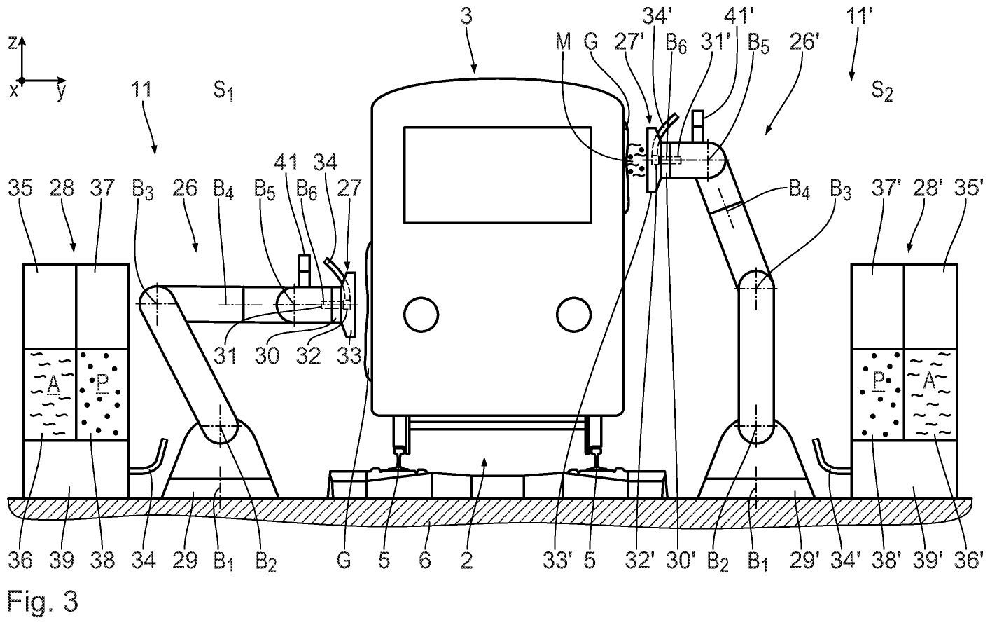

The respective cleaning element 32, 32′ is connected to the associated provision unit 28, 28′ by means of an associated mixture line 34, 34′. The mixture lines 34, 34′ are only indicated in FIG. 3.

The respective provision unit 28, 28′ has a compressed air generator 35, 35′, a compressed air reservoir 36, 36′ as well as a dry ice generator 37, 37′, and a dry ice reservoir 38, 38′. The compressed air reservoirs 36, 36′ and the dry ice reservoirs 38, 38′ are connected to a respectively associated metering unit 39, 39′, which supplies the associated mixture line 34, 34′ with the dry ice-compressed air mixture M. To provide liquid CO₂, the cleaning apparatus 4 comprises a CO₂ storage container 40. The CO₂ storage container 40 is connected to the dry ice generators 37, 37′ via lines that are not shown in more detail.

For identifying the detected soiling G, the multi-axis robots 26, 26′ comprise a respective digital camera 41, 41′, which recognize the already detected soiling G. The digital cameras 41, 41′ contain a respective light sensor or optical detector.

The inspection devices 12, 12′ are designed in accordance with the detection devices 10, 10′. The inspection devices 12, 12′ serve to detect soiling G on the rail vehicle 3 to be cleaned. The inspection devices 12, 12′ each comprise a column-like beam 42 or 42′ and associated digital cameras 43, 44 or 43′, 44′. The respective beam 42, 42′ is firmly connected to the ground 6. The digital cameras 43, 44, 43′, 44′ are arranged at a distance from one another in the vertical z-direction at the respective associated beam 42, 42′. The digital cameras 43, 44, 43′, 44′ have a respective detection area E. The digital cameras 43, 44, 43′, 44′ are arranged in such a way that the detection areas E completely cover the side walls W₁ and W₂ of the rail vehicle 3. The digital cameras 43, 44, 43′, 44′ have a respective light sensor or optical detector which converts light into image data in the usual manner. The image data is provided to the control device 13.

The operating principle of the cleaning station 1 is now described below.

The rail vehicle 3 with the soiling G is driven by a driver to the cleaning station 1. The rail vehicle 3 is, for example, a commuter train that has graffiti as soiling G. This soiling G is to be removed automatically in the cleaning station 1.

The travel motion control device 14 gives the driver a stop signal by means of the control element 21 arranged in front of the entrance 8. The travel motion control device 14 asks the vehicle control device 22 by means of the transmitting and receiving unit 18 whether the latter wishes to permit a signal connection. The driver can allow the signal connection for fully automatic control of the travel motion of the rail vehicle 3 in the cleaning station 1 by making a corresponding input in the vehicle control device 22. Alternatively, the driver may not permit the signal connection, so that the driver must move the rail vehicle 3 through the cleaning station 1 himself on the basis of the information provided by the travel motion control device 14. In this case, the travel motion of the rail vehicle 3 is controlled in a partially automated manner by means of the travel motion control device 14.

The fully automated control of the travel motion of the rail vehicle 3 is described below. In parallel with the fully automated control of the travel motion, the transmitting and receiving unit 18 transmits information to the control elements 21 about the desired travel motion, in particular about the travel speed and the travel direction, as well as information about whether the driver should slow down or speed up the rail vehicle 3 or stop it. The driver may abort the fully automatic control of the travel motion at any time and continue the travel motion in a partially automated manner on the basis of the information provided.

The rail vehicle 3 is first driven through the entrance 8 into the cleaning station 1. The rail vehicle 3 moves past the detection devices 10, 10′ at low speed so that they can detect the soiling G by means of the digital cameras 24, 24′, 25, 25′. The image data determined by the digital cameras 24, 24′, 25, 25′ are transmitted to the control device 13, which uses these image data to create a respective cleaning program for the cleaning devices 11, 11′. The respective cleaning program is processed in the cleaning control unit 16 and the cleaning devices 11, 11′ are controlled accordingly in dependence on the detected soiling G.

When the rail vehicle 3 reaches the cleaning devices 11, 11′, cleaning is started. The position of the soiling G in the x-direction can be determined in the automatic control of the travel motion on the basis of the distance in the x-direction between the detection devices 10, 10′ and the associated cleaning devices 11, 11′ and on the basis of the travel speed and/or identified in the automatic control or the partially automatic control of the travel motion by means of the digital cameras 41, 41′.

By means of the cleaning elements 32, 32′, the dry ice-compressed air mixture M is sprayed onto the soiling G so that they are removed as completely as possible. If necessary, the travel motion control device 14 slows down the travel speed and/or temporarily stops the rail vehicle 3. The respective cleaning element 32, 32′ is positioned according to the position of the soiling G by means of the associated multi-axis robot 26, 26′. The dry ice-compressed air mixture M is generated by means of the respective metering unit 39, 39′, which is supplied with dry ice P from the respective dry ice reservoir 38, 38′ and with compressed air A from the respective compressed air reservoir 36, 36′. The compressed air A is generated by means of the respective compressed air generator 35, 35′. The dry ice P or the dry ice pellets are generated by means of the respective dry ice generator 37, 37′ from liquid CO₂, which is stored in the CO₂ storage container 40.

A respective suction device not shown in more detail can additionally be connected to the protective covers 33, 33′ so that removed soiling G can be sucked out of the respective protective cover 33, 33′ and collected for disposal.

The rail vehicle 3 is moved to the inspection devices 12, 12′. The inspection devices 12, 12′ check whether the soiling G has been removed. For this purpose, image data is captured by means of the digital cameras 43, 43′, 44, 44′ and transmitted to the control device 13. In the control device 13, the image data of the inspection devices 12, 12′ are compared with the image data of the detection devices 10, 10′ and the cleaning result is documented and evaluated. If the evaluation results in an unacceptable cleaning result, a post-cleaning program is created by the control device 13 on the basis of the image data of the inspection devices 12, 12′. For post-cleaning, the rail vehicle 3 is first moved in the opposite direction to the process direction D to the extent required, so that residual soiling G is again positioned in front of the cleaning devices 11, 11′. Subsequently, a post-cleaning and removal of the residual soiling G takes place in a manner corresponding to the cleaning already described.

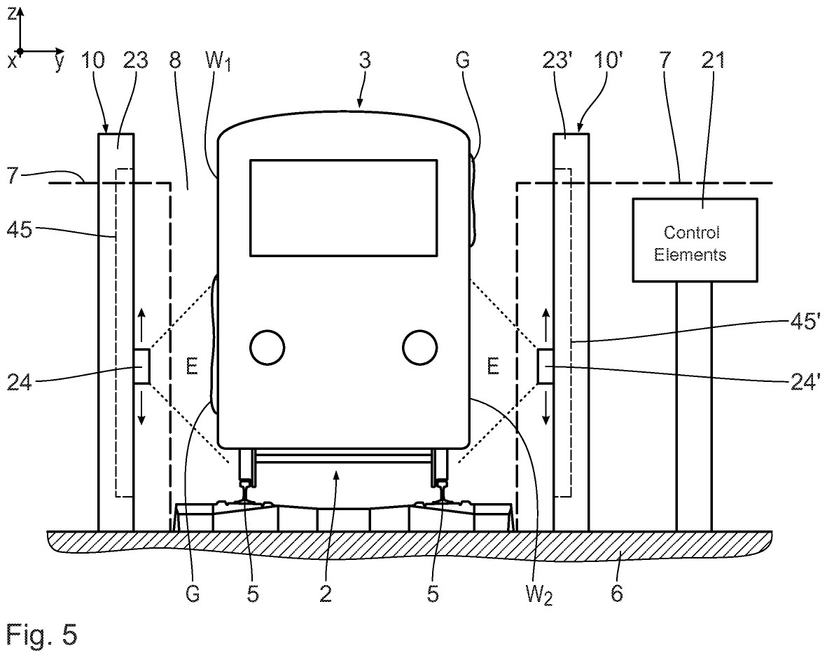

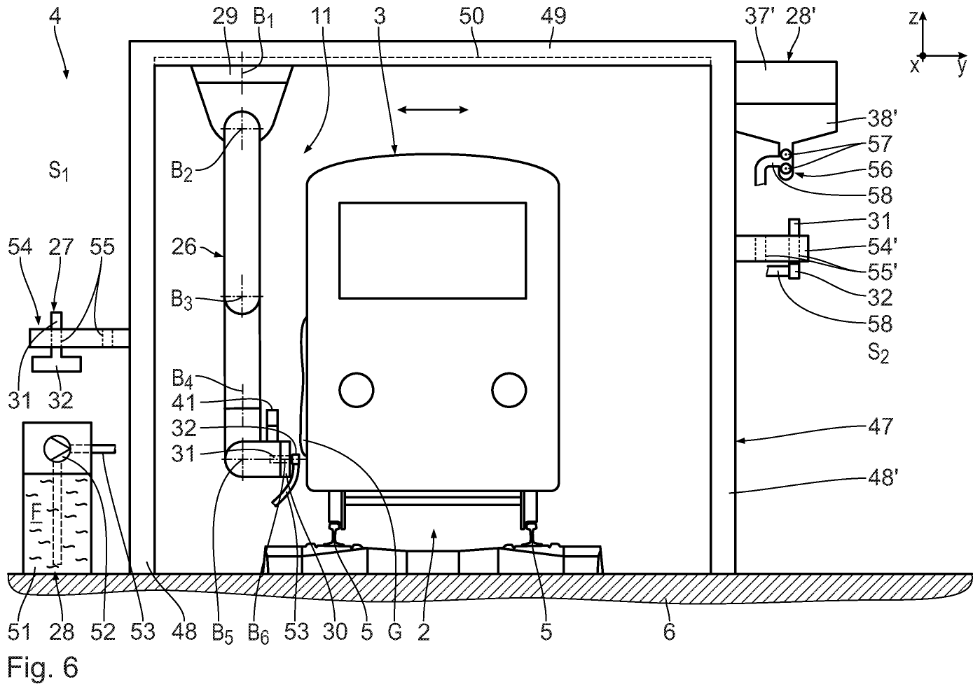

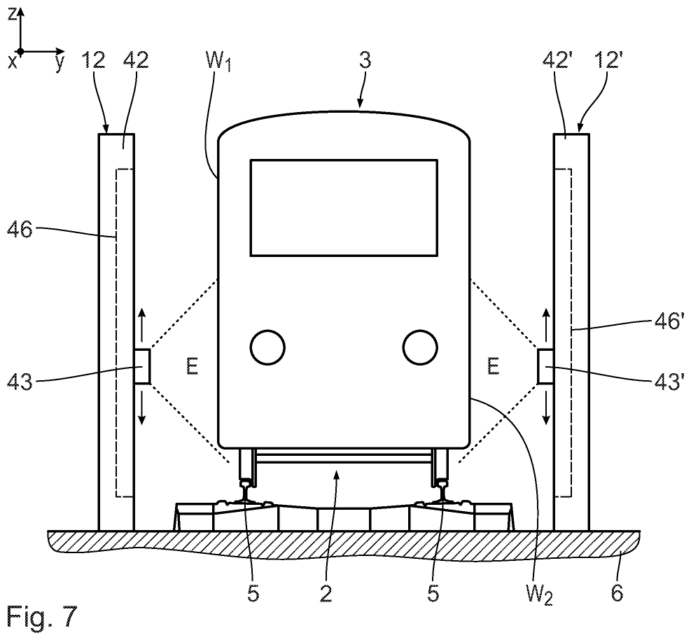

A second embodiment of the invention is described below with reference to FIGS. 5 to 7. In contrast to the previous embodiment, the detection devices 10, 10′ each have only one digital camera 24 or 24′, which can be moved linearly on the associated beam 23 or 23′ by means of a respective linear drive 45, 45′. To detect the soiling G, the digital cameras 24, 24′ are moved in such a way that the entire side wall W₁ or W₂ is captured with regard to possible soiling G by means of the respective detection area E.

Accordingly, the inspection devices 12, 12′ each have only one digital camera 43 or 43′, which can be moved linearly on the associated beam 42 or 42′ by means of a respective linear drive 46, 46′. To check the cleaning result, the digital cameras 43, 43′ are moved in such a way that the entire side wall W₁ or W₂ is captured with regard to residual soiling G by means of the respective detection area E.

The cleaning apparatus 4 has only one cleaning device 11. The cleaning device 11 contains a U-shaped beam 47 with two supports 48, 48′ to which a crossbeam 49 is attached. The beam 47 is thus of portal-like design. The supports 48, 48′ are attached to the ground 6. The cleaning device 11 contains only one multi-axis robot 26, which is arranged in a suspended manner from the crossbeam 49. The multi-axis robot 26 can be moved linearly in the y-direction on the crossbeam 49 by means of a linear drive 50.

The cleaning device 11 contains a first provision unit 28 for providing a chemical cleaning liquid F. The first provision unit 28 contains a reservoir 51 in the form of a container for holding the cleaning liquid F and a conveying element 52 in the form of a conveying pump to convey the cleaning liquid F. The conveying element 52 is connected to a first cleaning element 32 in the form of a nozzle by means of a line 53.

The cleaning apparatus 4 further comprises a magazine 54 for holding cleaning modules 27 or cleaning elements 32. The magazine 54 is arranged in an access area of the multi-axis robot 26, for example at the support 48. The magazine 54 contains a plurality of magazine receptacles 55. For example, a mechanical cleaning module 27 having a brush as a cleaning element 32 is arranged in a magazine receptacle 55.

The cleaning apparatus 4 further contains a second provision unit 28′ for providing a cleaning medium in the form of dry ice P. The provision unit 28′ contains a dry ice generator 37′ and a dry ice reservoir 38′. The dry ice reservoir 38′ opens into a dry ice dispenser 56, which contains two contact elements 57 which can be driven in rotation by means of a drive unit not shown in greater detail. The contact elements 57 are configured as contact rollers. By means of the contact elements 57, the dry ice pellets or the dry ice P are accelerated to a dispensing speed. The dispensing of the dry ice P or the dry ice pellets can be supported by compressed air A. The dry ice dispenser 56 is connected to a cleaning element 32 in the form of a nozzle via a line 58. The cleaning element 32 can be deposited in a magazine receptacle 55′ of a magazine 54′ corresponding to the magazine 54. With regard to the further construction and the further operating principle, reference is made to the preceding embodiment.

In general, the following applies.

The cleaning station 1 or the cleaning apparatus 4 is configured in such a way that a structure gauge of the vehicle or the rail vehicle 3 is not violated. The cleaning apparatus 4 is connected to a central power supply, preferably to the power supply network. The respective cleaning device 11, 11′ may also contain a plurality of multi-axis robots 26, 26′ if required. The passage through the cleaning station 1 preferably takes place at a travel speed of at most 10 km/h, in particular at most 5 km/h, and in particular at most 3 km/h.

1. A cleaning apparatus for cleaning a vehicle, the cleaning apparatus comprising:
at least one detector for detecting soiling on the vehicle to be cleaned;
at least one cleaning device for cleaning the vehicle and having at least one cleaning element, and at least one multi-axis robot for positioning said at least one cleaning element relative to the vehicle; and
a controller for controlling said at least one cleaning device in dependence on the soiling detected.

2. The cleaning apparatus according to claim 1, further comprising at least one inspection device for inspecting a cleaned vehicle.

3. The cleaning apparatus according to claim 2, wherein at least one of a group containing said at least one detector and said at least one inspection device each contain at least one digital camera.

4. The cleaning apparatus according to claim 2, wherein at least one of a group containing said at least one detector and said at least one cleaning device and said at least one inspection device are disposed one after another in a process direction.

5. The cleaning apparatus according to claim 1, wherein said at least one cleaning device has at least one support at which said at least one multi-axis robot is disposed.

6. The cleaning apparatus according to claim 1, wherein said at least one multi-axis robot has at least three movement axes.

7. The cleaning apparatus according to claim 1, wherein said at least one multi-axis robot has at least one sensor for detecting the soiling.

8. The cleaning apparatus according to claim 1, wherein said at least one cleaning device has at least one provision unit for providing a cleaning medium.

9. The cleaning apparatus according to claim 1, wherein said at least one cleaning device has at least one provision unit for providing dry ice.

10. The cleaning apparatus according to claim 9, wherein said at least one provision unit contains at least one of a group containing a dry ice generator and a dry ice reservoir.

11. The cleaning apparatus according to claim 8, wherein said at least one cleaning element includes at least one of a group containing a nozzle and a brush.

12. The cleaning apparatus according to claim 1, further comprising a travel motion controller for controlling a travel motion of the vehicle to be cleaned in dependence on the soiling detected.

13. The cleaning apparatus according to claim 1, wherein the vehicle is a rail vehicle.

14. A cleaning station for cleaning a vehicle, the cleaning station comprising:
a travel path; and
a cleaning apparatus, containing:
at least one detector for detecting soiling on the vehicle to be cleaned;
at least one cleaning device for cleaning the vehicle and having at least one cleaning element, and at least one multi-axis robot for positioning said at least one cleaning element relative to the vehicle; and
a controller for controlling said at least one cleaning device in dependence on the soiling detected.

15. The cleaning station according to claim 14, wherein at least one of a group containing said at least one detector and said at least one cleaning device and at least one inspection device are disposed at least one of one after another and laterally next to said travel path in a process direction.

16. The cleaning station according to claim 14, wherein:
said at least one detector includes a first detector and a second detector;
said at least one cleaning device includes a first cleaning device and a second cleaning device;
said at least one inspection device includes a first inspection device and a second inspection device;
at least one of a group containing said first detector, said first cleaning device and said first inspection device is disposed on a first side next to said travel path; and
at least one of a group containing said second detection device, said second cleaning device and said second inspection device is disposed on a second side next to said travel path.

17. The cleaning station according to claim 14, wherein:
the vehicle is a rail vehicle; and
said travel path is a track.

18. A method for cleaning a vehicle, which comprises the steps of:
providing a cleaning station, containing:
a travel path; and
a cleaning apparatus, including:
at least one detector for detecting soiling on the vehicle to be cleaned;
at least one cleaning device for cleaning the vehicle, said at least one cleaning device having at least one cleaning element and at least one multi-axis robot for positioning the least one cleaning element relative to the vehicle; and
a controller for controlling the at least one cleaning device in dependence on the soiling detected;
moving the vehicle along the travel path;
detecting the soiling on the vehicle by means of the at least one detector;
controlling the at least one cleaning device in dependence on the soiling detected by means of the controller; and
cleaning the vehicle by means of the at least one cleaning device.
